(19) United States
(12) Patent Application Publication
(10) Pub. No.: US 2007/0142077 A1
(43) Pub. Date: Jun. 21, 2007

(54) Hand-held device combining controller unit and mobile phone

(76) Inventor: Chiang-Shui Huang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/305,210

(22) Filed: Dec. 19, 2005

(51) Int. Cl. H04M 1/00

(52) U.S. Cl. 455/550.1

(57) ABSTRACT

A hand-held device combining mobile phone and controller unit, which comprises a telephone body, a cross-shaped key, a plurality of buttons and a control interface circuitry. The cross-shaped key is disposed on the edge of the telephone body for generating direction-controlling signals. The buttons are disposed on the edge of the telephone body for generating button-controlling signals. The control interface circuitry is disposed in the telephone body connecting with the telecommunication processor, the cross-shaped key, the buttons and video game devices. The control interface circuitry receives the direction-controlling signals and the button-controlling signals and converts the direction-controlling signals and the button-controlling signals to electric-controlling signals, and further outputs the electric-controlling signals to a video game device.

### BACKGROUND OF THE INVENTION

1. Field of the Invention

This invention generally relates to a mobile phone and a controller unit, and particularly to a hand-held device combining the mobile phone and the controller unit.

2. The Related Art

Recently, controller units are popularly used for game devices such as video game machines and desktop computers even notebook computers. With regard to notebook computers, the majority of notebook computers are provided with a touch-pad integrated therewith, which can be used for controlling video games with touching or pressing manipulation by fingers of a user. The problem is that, the touch-pad of the notebook computer cannot enable a user to attain the sensitivity and convenience of a controller unit. Thus, it requires the user to carry an additional controller unit together with the notebook computer so as to enjoy video games as much as the user likes. However, in consideration of the portability and convenience of the notebook computer, traditional controller units is not adapted to be carried together with the notebook computers.

Consequently, there is a need to provide a portable controller unit for resolving the above problem. At present, a mobile phone has become an indispensable device for a user to conveniently communicate. The mobile phone has advantages of convenient portability and expansibility. Therefore, it is possible to combine the mobile phone and the controller unit together as a single device for convenient carrying and being manipulated as a controller unit.

### SUMMARY OF THE INVENTION

It is an object of the present invention to provide a hand-held device combining controller unit and mobile phone which incorporates a controller unit and a mobile phone into a single, integrated computer peripheral device, for convenient carrying without occupying extra space.

It is another object of the present invention to provide a hand-held device combining controller unit and mobile phone which is able to operationally function both as a mobile phone for telecommunication and as a controller unit for convenient video game controlling, in conformance with convenient selections of operational modes by a user.

These objects mentioned above are achieved by a hand-held device combining controller unit and mobile phone together, which comprises a telephone body, a cross-shaped key, a plurality of buttons and a controlling interface circuitry. The telephone body has a telecommunication processor and a keypad. The telecommunication processor controls and processes telephone signals. The keypad generates input-signals in response to manual entry on the keypad. The cross-shaped key is disposed on the edge of the telephone body for generating direction-controlling signals corresponding to manual press on the cross-shaped key. The plurality of buttons is disposed on the edge of the telephone body for generating button-controlling signals corresponding to manual press on the buttons. The control interface circuitry is disposed in the telephone body, which connects with the telecommunication processor and is switched on and off by the telecommunication processor. The control interface circuitry connects with the cross-shaped key and the buttons, and switches on and off the function of the cross-shaped key and the buttons. The control interface circuitry receives the direction-controlling signals and the button-controlling signals and converts the direction-controlling signals and the button-controlling signals to electric-controlling signals.

As mentioned above, the present invention provides a hand-held device combining controller unit and mobile phone, which can be operated as a mobile phone as well as a controller unit. The hand-held device combines a mobile phone and a controller unit into a single compact hand-held device. Thus, it is convenient for users to carry the hand-held device, and conveniently to use as a controller unit when being connected to a notebook computer or other video game devices.

### BRIEF DESCRIPTION OF THE DRAWINGS

A detailed explanation of a preferred embodiment of the present invention will be given, with reference to the attached drawings, for better understanding thereof to those skilled in the art:

FIG. 1 is a perspective view of a first embodiment of a hand-held device in accordance with the present invention;

FIG. 2 is a block diagram of the first embodiment of the hand-held device shown in FIG. 1;

FIG. 3 is a block diagram of a control interface circuitry of the first embodiment;

FIG. 4 illustrates the hand-held device being applied to a host computer;

FIG. 5 is a block diagram of a second embodiment of the circuit configuration of the hand-held device;

FIG. 6 is perspective view of a third embodiment of the hand-held device;

FIG. 7 is a block diagram of the third embodiment of the circuit configuration of the hand-held device;

FIG. 8 is perspective view of a fourth embodiment of the hand-held device;

FIG. 9 is a block diagram of the fourth embodiment of the circuit configuration of the hand-held device;

FIG. 10 illustrates the hand-held device shown in FIG. 8 in an open condition.

### DETAILED DESCRIPTION OF THE PREFERRED EMBODIMENT

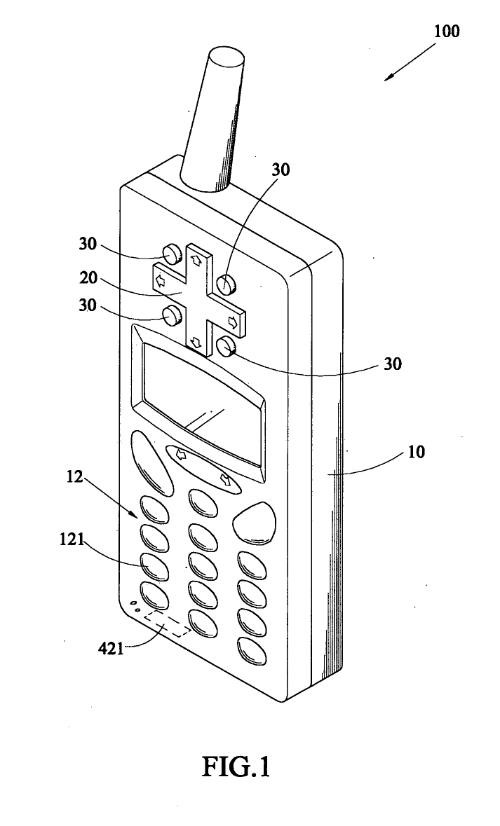

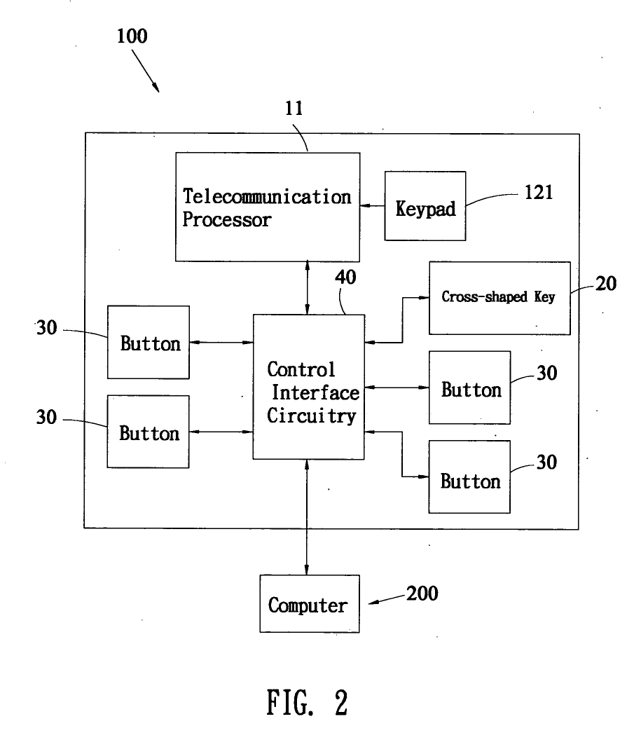

With reference to FIGS. 1 and 2, a hand-held device 100 combining controller unit and mobile phone, comprises a telephone body 10, a cross-shaped key 20, a plurality of buttons 30 and a control interface circuitry 40. A telecommunication processor 11 is disposed inside the telephone body 10 to control and process the telephone signals. A keypad 12 is located on the telephone body 10 for generating input-signals in response to manual entry on the keypad 12 to command the hand-held device 100 to perform corresponding communication function. A press key 121 of the keypad 12 is designed to be a controller unit mode switch for alternatively switching the controller unit mode on and off.

The cross-shaped key 20 is disposed on the edge of the telephone body 10. The first embodiment of present invention directs to a situation the cross-shaped key 20 is placed upon the keypad to make a description. Pressing the upper-part, lower-part, right-part and left-part of the cross-shaped key 20 generates direction-controlling signals.

The buttons 30 are disposed on the edge of the telephone body 10. In the first embodiment, the buttons 30 are placed upon the keypad 12. Pressing the buttons 30 generates button-controlling signals.

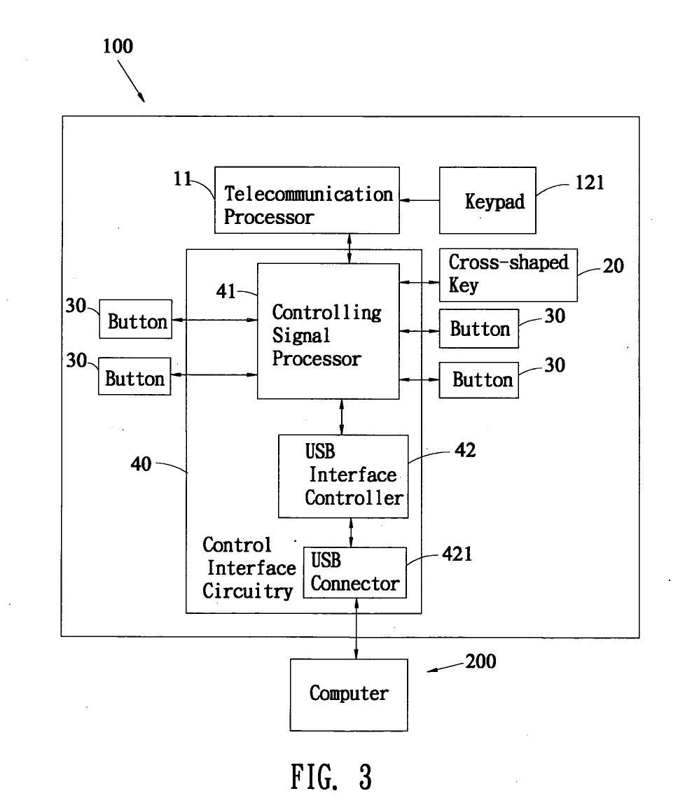

Referring to FIG. 3, the control interface circuitry 40 disposed inside the telephone body 10 is compatible with controller unit interface firmware. The interface standard of the control interface circuitry 40 is adapted to various industry controller unit interface standard. In a preferred embodiment, the interface of the control interface circuitry 40 is a USB (Universal Serial Bus) interface. Other interfaces such as RS-232, GAME PORT etc. are also available. The control interface circuitry 40 comprises a controlling signal processor 41 and a USB interface controller 42. The controlling signal processor 41 connects to the telecommunication processor 11. Thus, the telecommunication processor 11 controls and activates the control interface circuitry 40 through the press manipulation of the press key 121 of the keypad 12. For example, when the press key 121 is pressed for a first time, the telecommunication processor 11 activates the control interface circuitry 40, so the hand-held device 100 is operates in the controller unit mode. Thereafter, when the press key 121 is pressed again, the control interface circuitry 40 is inactivated, and the controller unit mode of the hand-held device 100 is off, while the telephone mode is on.

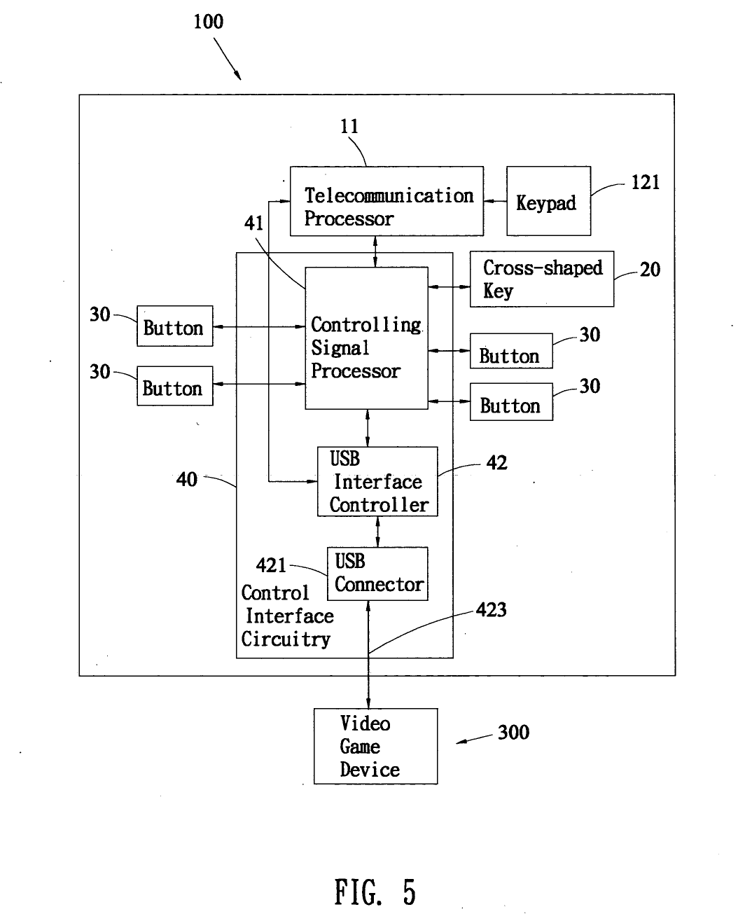

The cross-shaped key 20 and the buttons 30 are connected to the controlling signal processor 41. The function of the cross-shaped key 20 and the buttons 30 is switched on and off by the controlling signal processor 41. The controlling signal processor 41 receives the direction-controlling signals from the cross-shaped key 20 and the button-controlling signals from the buttons 30, and then processes direction-controlling signals and button-controlling signals into corresponding electric-controlling signals for being transmitted to video game machines 300 or computers 200 through the USB interface controller 42 (shown in FIG. 3 and FIG. 5).

Please referring to FIG. 3, the USB interface controller 42 is connected with the controlling signal processor 41, so as to receive the electric-controlling signals from the controlling signal processor 41 and convert the electric-controlling signals into corresponding USB standard signals. The USB interface controller 42 connects with a USB connecter 421 disposed on peripheral sides of the telephone body 10. The USB connecter 421 can connects with a USB port 210 provided at the host computer 200 through a USB cable 422. Therefore, the electric-controlling signals in USB standard are transmitted to the host computer 200 via the USB connecter 421, the USB cable 422 and the USB port 210. The host computer thus can perform video game controlling function corresponding to controlling the cross-shaped key 20 and the buttons 30. According to the present invention, the host computer 200 may be a desktop computer, a notebook computer or a tablet computer etc.

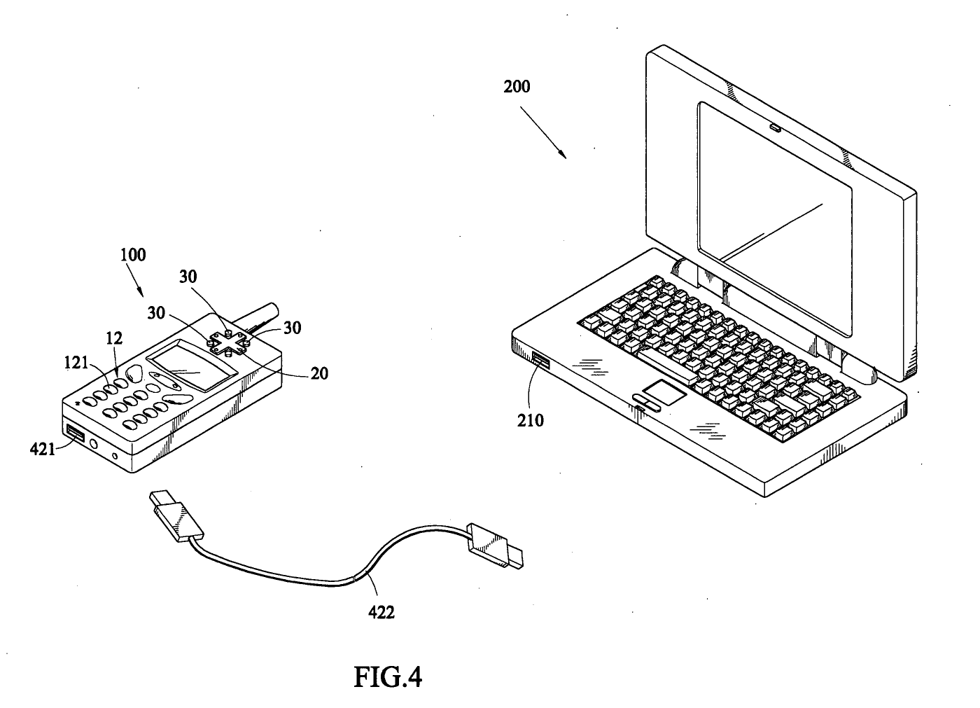

As shown in FIG. 4, when the hand-held device 100 is connected to the host computers 200. The press key 121 of the keypad 12 is pressed to activate the controller unit mode of the hand-held device 100, and the control interface circuitry 40 can transmit the electric-controlling signals to the host computer 200, so that the hand-held device 100 is operated as a common controller unit. If the hand-held device 100 wants to work as a mobile phone, the press key 121 is pressed again to switch the controller unit mode to the telecommunication mode, during which the telecommunication function is performed.

FIG. 5 shows a second embodiment of the hand-held device 100 according to the present invention. The USB connecter 421 of the USB interface controller 42 of the control interface circuitry 40 connects with a USB port 310 of a video game machine 300 by a USB cable 423. The video game machines 300 can be various video game devices such as the series of the XBOX of the MICROSOFT CORPORATION or the series of the PS2 of the SONY CORPORATION.

As shown in FIG. 5, the USB interface controller 42 of the control interface circuitry 40 is connected to the telecommunication processor 11 of the telephone body 10. In this embodiment, when the press key 121 inactivates the controller unit mode of the hand-held device 100. The telecommunication processor 11 can download digital data such as pictures, music, message etc. from external devices such as computers, hard disk, digital cameras and so on. The cross-shaped key 20 and the buttons 30 can be used as particular keys for executing particular function. When the press key 121 is pressed to activate the controller unit mode of the hand-held device 100, the operating of the press key 121 being pressed simultaneously switches off the function that the telecommunication processor 11 can download digital data from external devices.

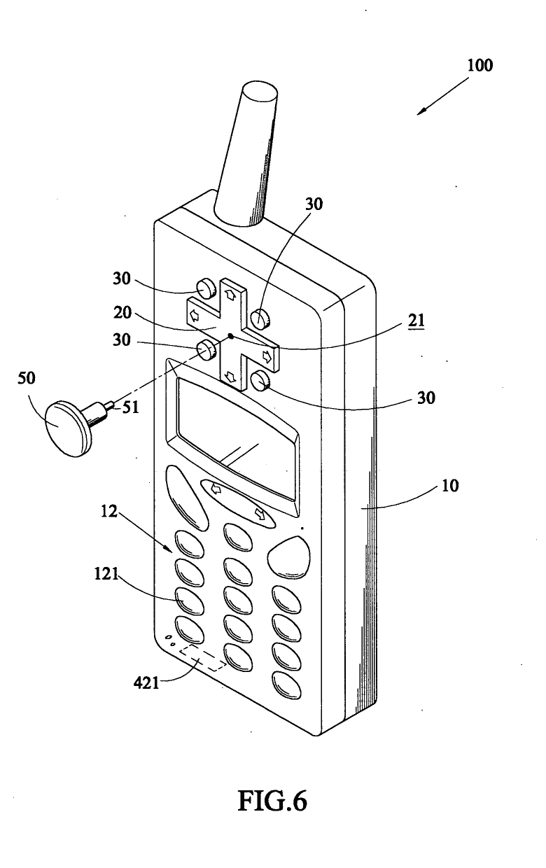

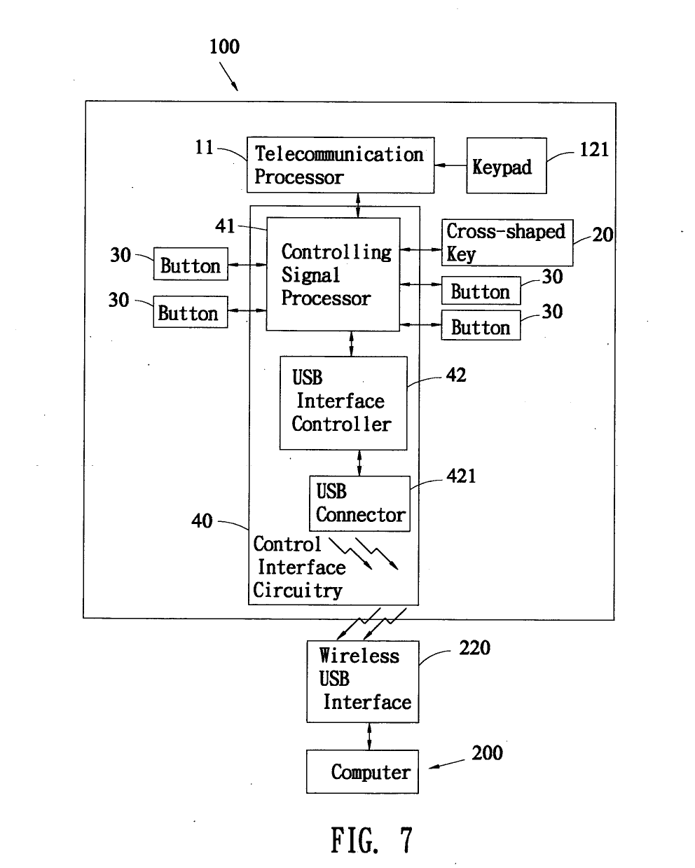

A third preferred embodiment of the hand-held device 100 is shown in FIG. 6 and FIG. 7. The hand-held device 100 further comprises a control bar 50 having a protuberance 51 formed at the end of the control bar 50. Corresponding to the protuberance 51 of the control bar 50, the cross-shaped key 20 is provided with a mounting hole 21 defined at the center thereof. The protuberance 51 of the control bar 50 is mounted in the mounting hole 21 of the cross-shaped key 20 so as to more conveniently control the cross-shaped key 20 by holding and wagging the control bar 50. The configuration manner between the control bar 50 and the cross-shaped key 20 should not be limited in the protuberance being formed on the control bar 50 and mounting hole being defined at the cross-shaped key 20. Hence the protuberance being formed on the cross-shaped key 20 and the mounting hole being defined at the control bar 50 or other similar configuration mode can be accepted as well.

The USB interface controller 42 shown in FIG. 7 has a wireless USB interface which can transmit the electric-controlling signals to a wireless USB interface 220 of the host computer 200. Similarly, these wireless USB interfaces can also be used in the hand-held device 100 and the video game machine 300 shown in FIG. 5.

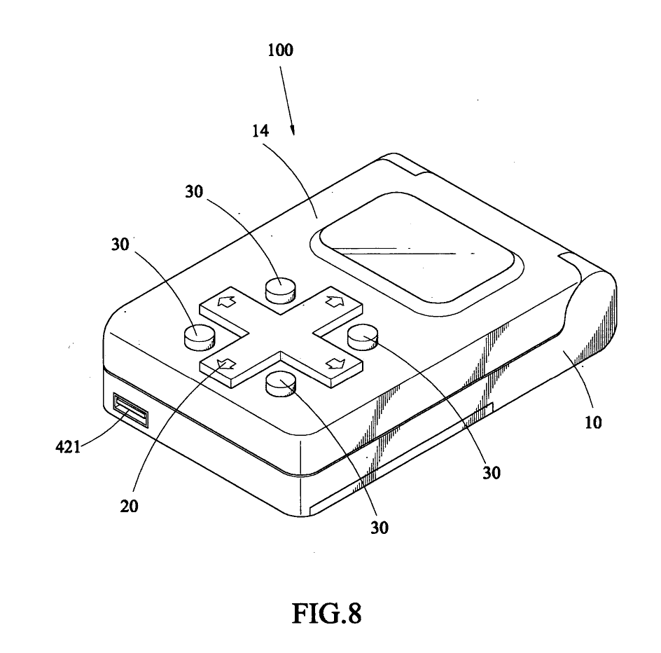

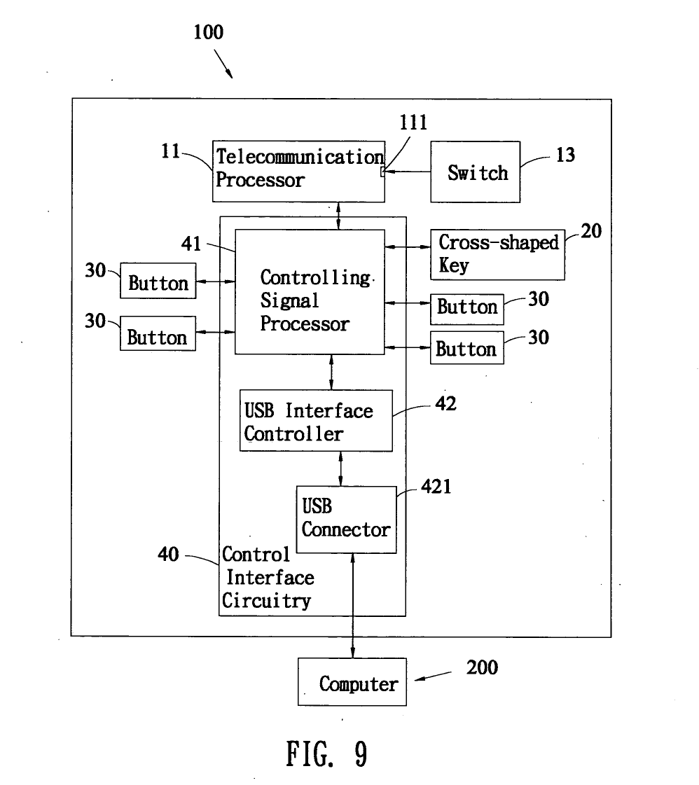

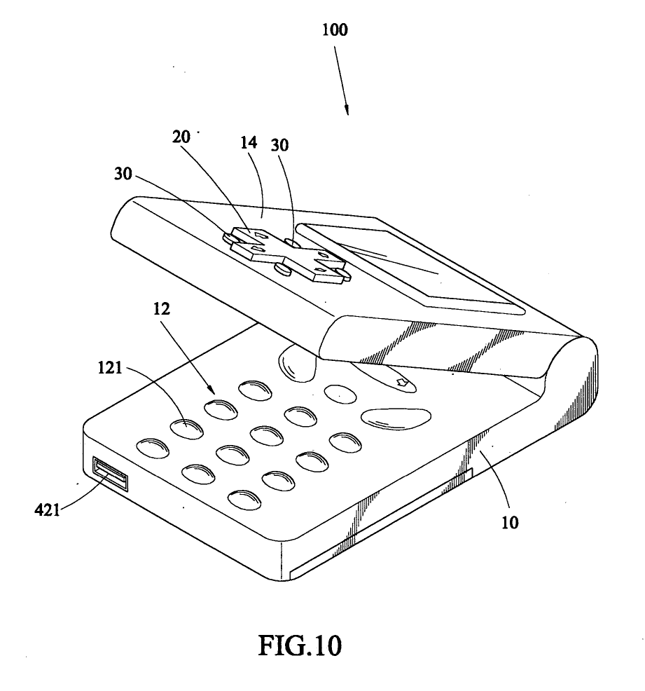

Referring to FIGS. 8, 9 and 10, the fourth embodiment of the hand-held device 100 is provided. In this embodiment, the telephone body 10 of the hand-held device 100 is a flip-style phone body (as shown in FIG. 8). A mode switch 13 is disposed on the telephone body 10 to detect whether an upper cover 14 of the telephone body 10 is folded so as to switch the telephone mode on and off. The mode switch 13 connects with a control pin 111 of the telecommunication processor 11 (as shown in FIG. 9). The mode switch 13 through the control pin 111 controls the telecommunication processor 11 so as to control whether to transmit the electric-controlling signals to the host computer 200 or not. In other words, while the control interface circuitry 40 is operated as a common controller unit, once the upper cover 14 is opened (as shown in FIG. 10) to make a phone call, the mode switch 13 generates and inputs a switching signal to the telecommunication processor 11 to switch off the controller unit mode of the hand-held device 100, and simultaneously shut off the transmission of the electric-controlling signals from the control interface circuitry 40 to the host computer 200. After the telecommunication, the upper cover 14 is folded, and the upper cover 14 depresses the mode switch 13, whereby the controller unit mode is switched on again. The control interface circuitry 40 is activated again to transmit the electric-controlling signals to the host computer 200. Thus, the hand-held device 100 operates in the controller unit mode again.

Although preferred embodiments of the present invention have been described in detail hereinabove, it should be clearly understand that many variations and/or modifications of the basic inventive concepts herein taught which may appear to those skilled in the present art will fall within the spirit and scope of the present invention, as defined in the appended claims.

What is claimed is:

1. A hand-held device combining mobile phone and controller unit, comprising:
a telephone body having a telecommunication processor and a keypad, the telecommunication processor controlling and processing telephone signals, the keypad generating input-signals in response to manual entry on the keypad;
a cross-shaped key being disposed on the edge of the telephone body for generating direction-controlling signals corresponding to manual press on the cross-shaped key;
a plurality of buttons being disposed on the edge of the telephone body for generating button-controlling signals corresponding to manual press on the buttons; and
a control interface circuitry disposed in the telephone body, the control interface circuitry connecting with the telecommunication processor and being switched on or off by the telecommunication processor, the control interface circuitry connecting with the cross-shaped key and the buttons and switching on or off the function of the cross-shaped key and the buttons, the control interface circuitry receiving the direction-controlling signals and the button-controlling signals and converting the direction-controlling signals and the button-controlling signals to electric-controlling signals.

2. The hand-held device as claimed in claim 1, wherein the telephone body has a mode switch connecting with a control pin of the telecommunication processor.

3. The hand-held device as claimed in claim 1, wherein the cross-shaped key connects with a control bar, and a protuberance is formed at the end of the control bar.

4. The hand-held device as claimed in claim 3, wherein the cross-shaped key defines a mounting hole at the center thereof in order to engage the protuberance.

5. The hand-held device as claimed in claim 1, wherein the control interface circuitry connects with a host computer.

6. The hand-held device as claimed in claim 1, wherein the control interface circuitry connects with a video game machine.

7. The hand-held device as claimed in claim 1, wherein the control interface circuitry includes a controlling signal processor connecting with the telecommunication processor and a USB interface controller connecting with the controlling signal processor.

8. The hand-held device as claimed in claim 7, wherein the USB interface controller has a USB connector.

9. The hand-held device as claimed in claim 7, wherein the USB interface controller has a wireless USB interface.

10. The hand-held device as claimed in claim 1, wherein the control interface circuitry includes a controlling signal processor connecting with the telecommunication processor and a USB interface controller connecting with the controlling signal processor and the telecommunication processor.

11. The hand-held device as claimed in claim 10, wherein the USB interface controller has a USB connector.

12. The hand-held device as claimed in claim 10, wherein the USB interface controller is a wireless USB interface.
